(19) United States
(12) Patent Application Publication
(10) Pub. No.: US 2016/0229166 A1
(43) Pub. Date: Aug. 11, 2016

(54) FILM ATTACHING APPARATUS

(71) Applicant: SAMSUNG DISPLAY CO., LTD., Yongin-si (KR)

(72) Inventors: Katsuhiko TANAKA, Cheonan-si (KR); Soo Chan LEE, Asan-si (KR); Jae Young KIM, Asan-si (KR); Dong Jin OK, Hwaseong-si (KR); Se Mi LEE, Incheon (KR); Jin Suk LEE, Yongin-si (KR)

(21) Appl. No.: 14/995,216

(22) Filed: Jan. 14, 2016

(30) Foreign Application Priority Data
Feb. 10, 2015 (KR) 10-2015-0020265

(51) Int. Cl. B32B 37/10; B32B 37/14

(52) U.S. Cl. CPC B32B 37/10; B32B 37/14; B32B 2307/746

(57) ABSTRACT

A film attaching apparatus for attaching a film to an object including a curved surface, including a support member having the object on an upper portion thereof; a belt member spaced apart from the support member upwardly and having a lower surface to which the film adheres and an upper surface having a first friction reducing layer; and an adherer spaced apart from the belt member upwardly and moving along an outer surface of the object to apply a pressure to the belt member so as to make the belt member adhere to the object on the support member.

### CROSS-REFERENCE TO RELATED APPLICATION

Korean Patent Application No. 10-2015-0020265 filed on Feb. 10, 2015, in the Korean Intellectual Property Office, and entitle: “Film Attaching Apparatus,” is incorporated by refrence herein in its entirety.

### BACKGROUND

1. Field

The present disclosure relates to a film attaching apparatus.

2. Description of the Related Art

A flexible display device may use a flexible display panel which may be bent to be able to display an image at a front and a side. The flexible display device may be variously applied to mobile devices such as a smart phone, a television set, an electronic book terminal, and an electronic newspaper terminal.

### SUMMARY

Embodiments may be realized by providing a film attaching apparatus for attaching a film to an object including a curved surface, including a support member having the object on an upper portion thereof; a belt member spaced apart from the support member upwardly and having a lower surface to which the film adheres and an upper surface having a first friction reducing layer; and an adherer spaced apart from the belt member upwardly and moving along an outer surface of the object to apply a pressure to the belt member so as to make the belt member adhere to the object on the support member.

The adherer may include a body part having an inner space; a pressed part adhering to the belt member and at one portion of the body part so that at least one portion of the pressed part is exposed outside the body part; a first slip part having a band shape, the first slip part to be slid along an end of the pressed part adhering to the belt member; a supply part to supply the first slip part to the pressed part; and a winding part to wind with the first slip part slid along the pressed part.

The adherer may further include a second friction reducing layer on at least one surface of the first slip part.

The adherer may include a body part having an inner space; a pressed part adhering to the belt member and at one portion of the body part so that at least one portion of the pressed part is exposed outside the body part; a second slip part having a band shape of a closed curved line, the second slip part to be slid along an end of the pressed part adhering to the belt member; and a rotating part to supply the second slip part slid along the pressed part to the pressed part.

The adherer may further include a third friction reducing layer on at least one surface of the second slip part.

The end of the pressed part adhering to the belt member may be rounded.

A radius of the end of the pressed part may range from 1 mm to 5 mm.

The first friction reducing layer may include fluororesin or silicone.

The belt member may include metal.

The belt member may include stainless steel.

A thickness of the belt member may range from 20 μm to 200 μm.

The film attaching apparatus may further include a driver coupled with the adherer to move the adherer in multiple directions.

The film attaching apparatus may further include a rotator having a first portion coupled with the driver and a second portion rotatably coupled with the adherer.

The film attaching apparatus may further include a controller to control rotation of the rotator so that the adherer is in a vertical state to a virtual tangential line of the curved surface of the object.

### BRIEF DESCRIPTION OF THE DRAWINGS

Features will become apparent to those of skill in the art by describing in detail exemplary embodiments with reference to the attached drawings in which:

FIG. 1 illustrates a diagram of a film attaching apparatus according to an exemplary embodiment;

FIG. 2 illustrates a diagram of an example of a structure of an adhesion unit included in the film attaching apparatus according to the exemplary embodiment illustrated in FIG. 1;

FIG. 3 illustrates a diagram of a modified example of the adhesion unit included in the film attaching apparatus according to the exemplary embodiment;

FIG. 4 illustrates a diagram of a rotating unit in the film attaching apparatus according to the exemplary embodiment illustrated in FIG. 1;

FIGS. 5 to 7 illustrate diagrams for describing a process of attaching a film to a window using the film attaching apparatus according to the exemplary embodiment illustrated in FIG. 1;

FIG. 5 illustrates a diagram of a process of compressing, by an adhesion unit, a center of a belt member;

FIG. 6 illustrates a diagram of a process of compressing, by an adhesion unit, the belt member while the adhesion unit moving in a left direction based on a center of an object; and

FIG. 7 illustrates a diagram of a process of compressing, by the adhesion unit, the belt member while the adhesion unit moving in a right direction based on the center of the object.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

In addition, in several exemplary embodiments, components having the same configuration will be representatively described using the same reference numerals in an exemplary embodiment, and only components different from those of an exemplary embodiment will be described in the other exemplary embodiments.

In addition, unless explicitly described to the contrary, the word “comprise” and variations such as “comprises” or “comprising”, will be understood to imply the inclusion of stated elements but not the exclusion of any other elements.

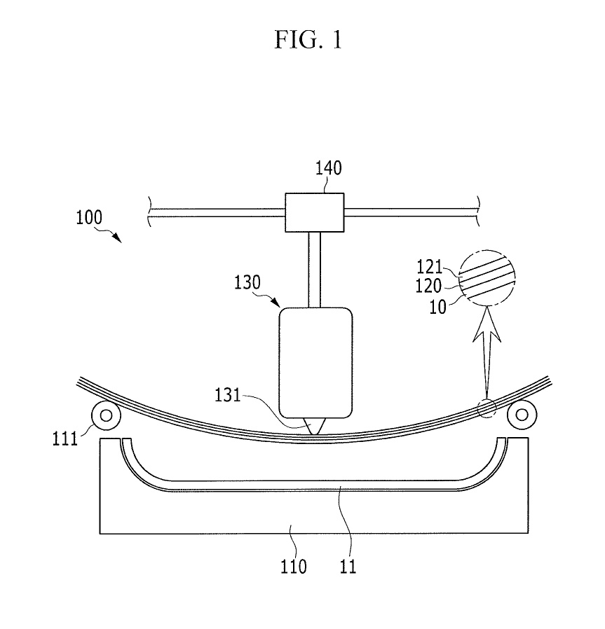

FIG. 1 illustrates a diagram of a film attaching apparatus according to an exemplary embodiment.

Referring to FIG. 1, a film attaching apparatus 100 according to an exemplary embodiment may be a film attaching apparatus 100 for attaching a film 10 to an object 11 including a curved surface and may include a support member 110, a belt member 120, and an adhesion unit 130.

The support member 110 may have the object 11 seated on an upper portion thereof. The upper portion of the support member 110 may be provided with a groove in which the object 11 may be seated. The support member 110 may be fixed to a ground or a structure. As a method for fixing, by the support member 110, the object 11, a vacuum adsorption method may be used. In an embodiment, any method for fixing, by the support member 110, the object 11 may be used.

The object 11 may be a window which may protect a display outputting an image in a mobile communication terminal. The window may be formed in, for example, a curved surface as a whole. As another example, the window may have left and right edge portions which may be only formed in a curved surface and a middle portion which may be formed in a plane.

The film 10 attached to the object 11 may be, for example, an optical clear tape. The optical clear tape may be attached with a flexible panel. The optical clear tape may be attached to an outer surface of a display panel of a mobile communication terminal but a detailed description thereof will be omitted.

The belt member 120 may be positioned to be spaced apart from the support member 110 upwardly. The film 10 may adhere to a lower surface of the belt member 120. The first friction reducing layer 121 for reducing a friction force, e.g., between the pressed part 131 and the belt member 120, may be formed on an upper surface of the belt member 120. The first friction reducing layer 121 may be made of materials, such as fluororesin or silicone. For example, the fluororesin may be less expensive and have better friction reducing performance than other materials.

When the adhesion unit 130 to be described below contacts the belt member 120, the friction between the adhesion unit 130 and the belt member 120 may be reduced by the first friction reducing layer 121, and the adhesion unit 130 may more smoothly and rapidly move along the upper surface of the belt member 120. The time to attach the film 10 may be reduced, and the tact time to attach the film 10 to the object 11 may be reduced as a whole. When the film attaching apparatus 100 according to an exemplary embodiment is used to manufacture the mobile communication terminal, the manufacturing time of the mobile communication terminal may be shortened, and productivity may be improved.

The foregoing belt member 120 may be made of metal. For example, the belt member 120 may be made of stainless steel. A thickness of the belt member 120 may range from 20 μm to 200 μm.

The adhesion unit 130 may be formed to be spaced apart from the belt member 120 upwardly. The adhesion unit 130 may move along the outer surface of the object 11 to apply a pressure to the belt member 120 to make the belt member 120 adhere to the object 11 seated on the support member 110.

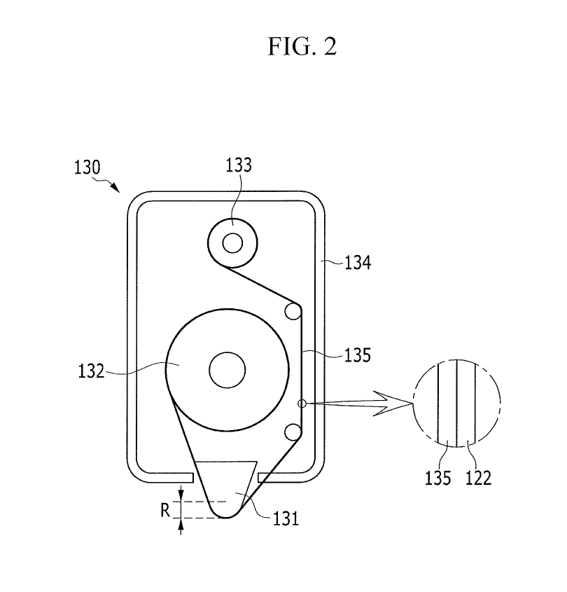

FIG. 2 illustrates a diagram of an example of a structure of the adhesion unit included in the film attaching apparatus according to the exemplary embodiment illustrated in FIG. 1.

Referring to FIG. 2, a detailed structure of the foregoing adhesion unit 130 may include, for example, a body part 134, a pressed part 131, a first slip part 135, a supply part 132, and a winding part 133.

The body part 134 may be provided with an inner space. The inner space may be provided with the pressed part 131, the first slip part 135, the supply part 132, and the winding part 133 which will be described below.

The pressed part 131 may be positioned at one portion of the body part 134 so that at least one portion of the pressed part 131 may be exposed outside the body part 134. For example, as illustrated in FIG. 2, the pressed part 131 may be formed so that a lower end of the pressed part 131 may be partially exposed downwardly from the body part 134. A portion exposed from the pressed part 131 may press the belt member 120.

The pressed part 131 may adhere to the belt member 120. A shape of the pressed part 131 may be, for example, a triangle. The belt member 120 may adhere to the object 11 by the pressed part 131.

An end of the pressed part 131 adhering to the belt member 120 may be formed to be rounded. As the end of the pressed part 131 is formed to be rounded, the pressed part 131 may more smoothly move while the pressed part 131 moves while pressing the belt member 120.

A radius R of the end of the pressed part 131 which may be formed to be rounded may range from 1 mm to 5 mm, and even though a curvature radius of the curved portion of the object 11 may be as small as 1 mm, the pressed part 131 may attach the film 10 to the curved portion of the object 11 without any gap.

The first slip part 135 may have a band shape, and may be positioned to be slid along the end of the pressed part 131 adhering to the belt member 120.

The supply part 132 may supply the first slip part 135 to the pressed part 131.

The winding part 133 may be wound with the first slip part 135, which may be slid along the pressed part 131. One end of the first slip part 135 may be fixed to the supply part 132 and the other end thereof may be fixed to the winding part 133. When the first slip part 135 wound around the supply part 132 is completely wound around the winding part 133 while the adhesion unit 130 moves along the belt member 120, the supply part 132 may rotate for the time during which the adhesion unit 130 may not be operated, and the first slip part 135 wound around the winding part 133 may be wound around the supply part 132. The supply part 132 may be provided with a motor.

The adhesion unit 130 may further include a second friction reducing layer 122. The second friction reducing layer 122 may be formed on at least one surface of the first slip part 135 to reduce a friction force, e.g., between the pressed part 131 and the belt member 120. For example, the second friction reducing layer 122 may be formed on a contact surface with the belt member 120 in the first slip part 135 and may be formed on a contact surface with the pressed part 131. The second friction reducing layer may be formed on both surfaces of the first slip part 135. The second friction reducing layer may be made of the same material as the foregoing first friction reducing layer 121.

While the adhesion unit 130 having the above structure moves along the outer surface of the belt member 120, the friction between the adhesion unit 130 and the belt member 120 may be reduced while the first slip part 135 moves in an opposite direction to a moving direction of the adhesion unit 130. For example, when the adhesion unit 130 moves to the left along the outer surface of the belt member 120, the first slip part 135 may move to the right while being released from the supply part 132 to be wound around the winding part 133.

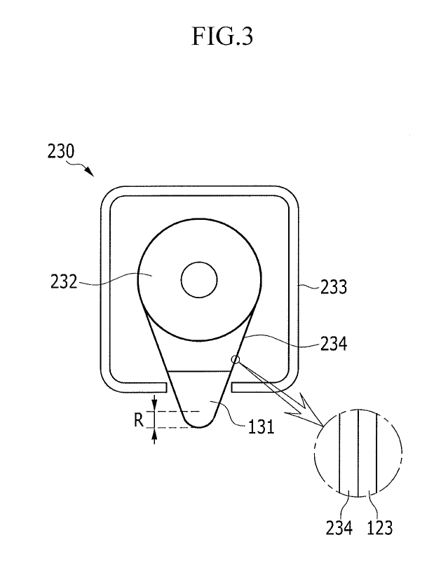

FIG. 3 illustrates a diagram of a modified example of the adhesion unit 130 included in the film attaching apparatus 100 according to the exemplary embodiment.

Referring to FIG. 3, a detailed structure of an adhesion unit 230 according to the modified example may include, for example, the body part 233, the pressed part 131, a second slip part 234, and a rotating part 232.

The body part 233 and the pressed part 131 may be the same as the body part 134 and the pressed part 131 included in the above-mentioned adhesion unit 130, and the descriptions thereof will be omitted.

The second slip part 234 may be formed in a band shape of a closed curved line. The second slip part 234 may be positioned to be slid along the end of the pressed part 131 adhering to the belt member 120. For example, the pressed part 131 and the rotating part 232 may be positioned inside the second slip part 234 and may tightly support the second slip part 234.

The rotating part 232 again may supply the second slip part 234 slid along the pressed part 131 to the pressed part 131. The rotating part 232 may be, for example, a roller. The second slip part 234 may smoothly rotate by the rotating part 232.

The adhesion unit 130 may further include a third friction reducing layer 123. The third friction reducing layer 123 may be formed on at least one surface of the second slip part 234 to reduce a friction force, e.g., between the pressed part 131 and the belt member 120. For example, a third friction reducing layer 123 may be formed on a contact surface with the belt member 120 in the second slip part 234 and may also be formed on a contact surface with the pressed part 131. The third friction reducing layer may be formed on both surfaces of the second slip part 234. The third friction reducing layer may be made of the same material as the foregoing first friction reducing layer 121 (see FIG. 2).

The adhesion unit 230 according to the modified example may have a simpler structure than the foregoing adhesion unit 130 (see FIG. 2), and manufacturing time may be shortened and manufacturing costs may be saved.

Referring back to FIG. 1, the film attaching apparatus 100 according to the exemplary embodiment may include the driving unit 140. The driving unit 140 may move the adhesion unit 130 along the outer surface of the object 11. The driving unit 140 may be coupled with the adhesion unit 130. The driving unit 140 may move the adhesion unit 130 in multiple directions.

The driving unit 140 may include, for example, an air cylinder and a rail. The air cylinder may move the adhesion unit 130 in a direction far away from or closed to the support member 110. A rail may move the adhesion unit 130 along a length direction of the support member 110. The air cylinder may move the adhesion unit 130 vertically and the rail may move the adhesion unit 130 horizontally.

The rail may be, for example, a linear motion (LM) guide. The LM guide is an apparatus which may be used to linearly move the specific member in one direction and a detailed description thereof will be omitted.

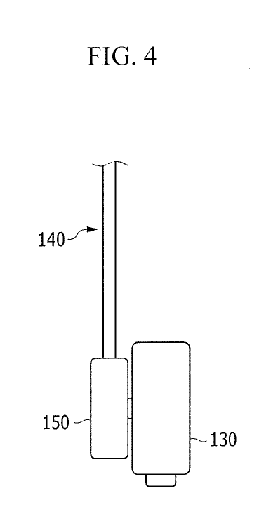

FIG. 4 illustrates a diagram of the rotating unit in the film attaching apparatus according to the exemplary embodiment illustrated in FIG. 1.

The film attaching apparatus 100 (see FIG. 1) according to the exemplary embodiment may further include the rotating unit 150.

The rotating unit 150 may be formed at a portion where the driving unit 140 may be connected to the adhesion unit 130. The rotating unit 150 may be rotatably coupled with the adhesion unit 130. The rotating unit 150 may make the adhesion unit 130 rotate corresponding to a curved surface of the object 11 (see FIG. 1).

The rotating unit 150 may include, for example, a rotating motor. The adhesion unit 130 may be coupled with a rotating shaft of the rotating motor. A reducer may be installed in the rotating motor and then may be coupled with the adhesion unit 130. The reducer may increase or reduce a torque of the adhesion unit 130. The reducer may be used to change the torque in a general mechanism, and a detailed description thereof will be omitted.

The film attaching apparatus 100 (see FIG. 1) according to the exemplary embodiment may further include a controller.

The controller may control the rotation of the rotating unit 150 so that the adhesion unit 130 is in a vertical state to a virtual tangential line of the curved surface of the object 11 (see FIG. 1). The controller may control the rotation of the rotating unit 150 depending on shape information of the object 11 (see FIG. 1). The controller may be a microprocessor, which may be installed in one of, for example, the rotating unit 150 and the adhesion unit 130. In an embodiment, the controller may be used to control the film attaching apparatus 100 (see FIG. 1) according to the exemplary embodiment as a whole.

A method for controlling, by a controller, a rotation of a rotating unit 150 may control the rotation of the rotating unit 150 by, for example, analyzing data of the curved portion from pre-stored window shape data. In an embodiment, when the window shape data is not stored, the controller may scan the window shape using a separate camera to acquire image data and then may analyze the acquired image data to control the rotation of the rotating unit 150.

In an embodiment, a method for controlling, by a controller, a rotation of a rotating unit 150 may vary from the foregoing method.

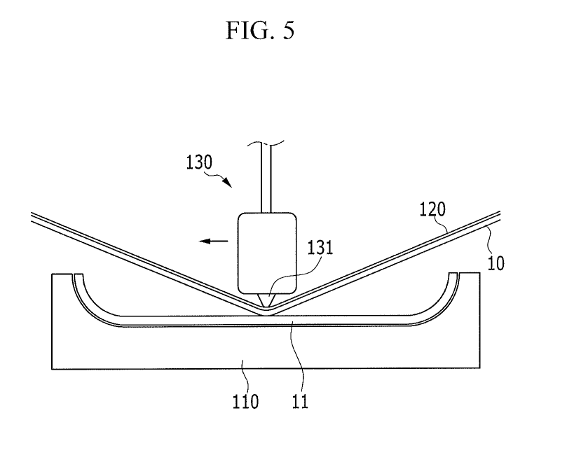

FIGS. 5 to 7 illustrate diagrams for describing a process of attaching a film to a window using the film attaching apparatus according to the exemplary embodiment illustrated in FIG. 1.

Hereinafter, a process of attaching a film 10 to a window which may be an object 11 using the film attaching apparatus 100 according to the exemplary embodiment having the structure as described above will be described in detail with reference to the drawings.

FIG. 5 illustrates a diagram of a process of compressing, by an adhesion unit, a center of a belt member.

As illustrated in FIG. 5, the pressed part 131 of the adhesion unit 130 may compress a portion corresponding to a middle portion of the object 11 in the belt member 120. The film 10 adhering to the lower surface of the belt member 120 may be attached to the middle portion of the window 11. Next, the adhesion unit 130 may move to the left or right.

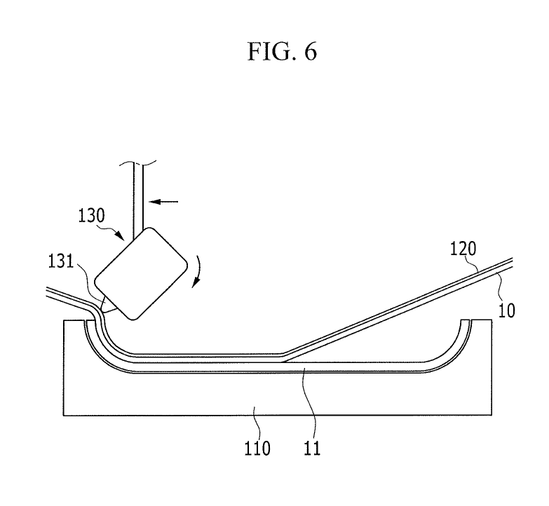

FIG. 6 illustrates a diagram of a process of compressing, by an adhesion unit, the belt member while the adhesion unit moving in a left direction based on a center of an object.

As illustrated in FIG. 6, the film 10 may be attached to the window 11 by pressing the belt member 120 while the adhesion unit 130 moves to the left. When the adhesion unit 130 moves along the window 11 and then is positioned at the curved portion of the left edge of the window 11, the adhesion unit 130 may be positioned to correspond to the curved surface of the window 11 while rotating clockwise. Therefore, the pressed part 131 may be vertically positioned to the virtual tangential line of the curved portion of the window 11, a force may be uniformly applied to the belt member 120, and the film 10 may be more stably attached to the window 11.

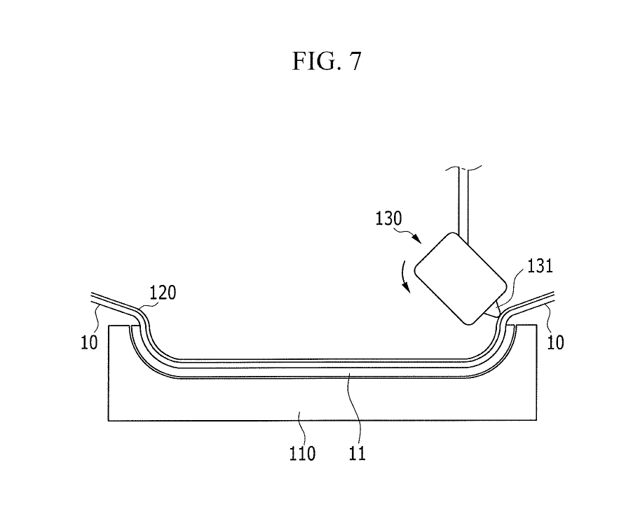

FIG. 7 illustrates a diagram of a process of compressing, by the adhesion unit, the belt member while the adhesion unit moving in a right direction based on the center of the object.

As illustrated in FIG. 7, the film 10 may be attached to the window 11 by pressing the belt member 120 while the adhesion unit 130 moves to the right. When the adhesion unit 130 moves along the window 11 and then is positioned at the curved portion of the right edge of the window 11, the adhesion unit 130 may be positioned to correspond to the curved surface of the window 11 while rotating counterclockwise.

In an embodiment, the adhesion unit 130 may move in the left direction based on the center of the object 11 and then may move in the right direction. In an embodiment, the adhesion unit 130 may move in the right direction based on the center of the object 11 and then may move in the left direction may be possible. The movement direction of the adhesion unit 130 may be freely changed according to a design.

The film attaching apparatus 100 according to the exemplary embodiment having the foregoing structure may include the belt member 120 formed with the first friction reducing layer 121 (see FIG. 1). It may be possible to more smoothly and rapidly move the adhesion unit 130 along the upper surface of the belt member 120 by using the first friction reducing layer 121 (see FIG. 1) to reduce the friction between the adhesion unit 130 and the belt member 120.

Therefore, the time to attach the film 10 may be reduced, and the tact time to attach the film 10 to the object 11 may be reduced as a whole. Therefore, when the film attaching apparatus 100 according to an exemplary embodiment is used to manufacture the mobile communication terminal, the manufacturing time of the mobile communication terminal may be shortened, and productivity may be improved.

By way of summation and review, a flexible display device may include a cover window on an uppermost end of a stacked layer to protect the flexible display panel. An optical film may be interposed between the panel and the cover window.

When the cover window has a two-dimensional plane structure, an optical film may be attached by a comparative pressure rolling attachment scheme or vacuum surface compression scheme.

The comparative pressure rolling attachment scheme and vacuum surface compression scheme may generate bubbles at the time of bonding the flexible display panel to the cover window having a three-dimensional structure, which may lead to deterioration in quality of the flexible display device.

When the cover window has a three-dimensional shape including a curved surface, it may be difficult to machine a roller corresponding to the cover window in three dimension, and it may be difficult for the comparative pressure rolling attachment scheme to bond the three-dimensional cover window to the flexible display panel.

Provided is a film attaching apparatus that may easily attach an optical film to a window including a curved surface.

According to an exemplary embodiment, the film attaching apparatus may include a belt member in which the first friction reducing layer may be formed. It may be possible to more smoothly and rapidly move the adhesion unit along the upper surface of the belt member by using the first friction reducing layer to reduce the friction between the adhesion unit and the belt member.

It may be possible to reduce the tact time to attach the film to the object as a whole by reducing the film attached time, and when the film attaching apparatus according to an exemplary embodiment is used to manufacture the mobile communication terminal, the manufacturing time of the mobile communication terminal may be shortened, and productivity may be improved.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A film attaching apparatus for attaching a film to an object including a curved surface, comprising:
a support member having the object on an upper portion thereof;
a belt member spaced apart from the support member upwardly and having a lower surface to which the film adheres and an upper surface having a first friction reducing layer; and
an adherer spaced apart from the belt member upwardly and moving along an outer surface of the object to apply a pressure to the belt member so as to make the belt member adhere to the object on the support member.

2. The film attaching apparatus as claimed in claim 1, wherein the adherer includes:
a body part having an inner space;
a pressed part adhering to the belt member and at one portion of the body part so that at least one portion of the pressed part is exposed outside the body part;
a first slip part having a band shape, the first slip part to be slid along an end of the pressed part adhering to the belt member;
a supply part to supply the first slip part to the pressed part; and
a winding part to wind with the first slip part slid along the pressed part.

3. The film attaching apparatus as claimed in claim 2, wherein the adherer further includes a second friction reducing layer on at least one surface of the first slip part.

4. The film attaching apparatus as claimed in claim 1, wherein the adherer includes:
a body part having an inner space;
a pressed part adhering to the belt member and at one portion of the body part so that at least one portion of the pressed part is exposed outside the body part;
a second slip part having a band shape of a closed curved line, the second slip part to be slid along an end of the pressed part adhering to the belt member; and
a rotating part to supply the second slip part slid along the pressed part to the pressed part.

5. The film attaching apparatus as claimed in claim 4, wherein the adherer further includes a third friction reducing layer on at least one surface of the second slip part.

6. The film attaching apparatus as claimed in claim 2, wherein the end of the pressed part adhering to the belt member is rounded.

7. The film attaching apparatus as claimed in claim 2, wherein a radius of the end of the pressed part ranges from 1 mm to 5 mm.

8. The film attaching apparatus as claimed in claim 1, wherein the first friction reducing layer includes fluororesin or silicone.

9. The film attaching apparatus as claimed in claim 1, wherein the belt member includes metal.

10. The film attaching apparatus as claimed in claim 9, wherein the belt member includes stainless steel.

11. The film attaching apparatus as claimed in claim 1, wherein a thickness of the belt member ranges from 20 μm to 200 μm.

12. The film attaching apparatus as claimed in claim 1, further comprising a driver coupled with the adherer to move the adherer in multiple directions.

13. The film attaching apparatus as claimed in claim 12, further comprising a rotator having a first portion coupled with the driver and a second portion rotatably coupled with the adherer.

14. The film attaching apparatus as claimed in claim 13, further comprising a controller to control rotation of the rotator so that the adherer is in a vertical state to a virtual tangential line of the curved surface of the object.
